(19) United States
(12) Patent Application Publication
(10) Pub. No.: US 2003/0168532 A1
(43) Pub. Date: Sep. 11, 2003

(54) Fuel injection valve

(76) Inventor: Dieter Maier, Isle of Palms, SC (US)

Correspondence Address: KENYON & KENYON, ONE BROADWAY, NEW YORK, NY, 10004, US

(21) Appl. No.: 10/258,298

(22) PCT Filed: Feb. 22, 2002
(86) PCT No.: PCT/DE02/00644

(30) Foreign Application Priority Data
Feb. 22, 2001 (DE) 101 08 464.1

(51) Int. Cl. B05B 15/08

(52) U.S. Cl. 239/587.1

(57) ABSTRACT

A fuel injector comprises a magnet coil which coacts with an armature that is impinged upon by a return spring and is configured together with a valve needle, a valve closure member that, with a valve seat element, forms a sealing seat being configured on the valve needle; and comprises at least one contact lug that is conductively connected to the magnet coil. A metal hollow body forms an inlet-side extension of the fuel injector, a connector plug having a contact lug being attachable onto the metal hollow body in such a way that the contact lug of the connector plug can be brought into conductive connection with the contact lug (6) of the magnet coil.

### BACKGROUND OF THE INVENTION

The invention proceeds from a fuel injector according to the species defined in the main claim.

DE 198 53 102 A1 discloses a fuel injector for internal combustion engines that is put together from two preassembled independent assemblages. A functional part substantially encompasses an electromagnetic circuit and a sealing valve, while a connector part is constituted principally by a hydraulic connector and an electrical connector. In the completely assembled fuel injector, electrical connecting elements and hydraulic connecting elements of the two assemblages coact to ensure a reliable electrical and hydraulic connection. Mechanical joining of the two assemblages and good stability of the fuel injector, as well as sufficient sealing, are ensured by an injection-molded sheath around the join region.

The fuel injector known from DE 198 53 102 A1 is disadvantageous in particular because the electrical plug contact produced integrally with the injection-molded sheath can be adapted only with great complexity (by retooling the injection-molding machines) to different plug connector systems.

In addition, the fact that fuel passes through the injection-molded plastic connector part is disadvantageous because the plastic is exposed to the dissolving ability of the fuel, and leaks can thereby occur due to dissolution of the plastic. The stability of the connector during operation of the internal combustion engine is also not sufficiently ensured, due to heating and subsequent deformation.

### ADVANTAGES OF THE INVENTION

The fuel injector according to the present invention having the characterizing features of the main claim has, in contrast, the advantage that the metal hollow body which is inserted into an inflow end of the valve sleeve of the fuel injector not only stabilizes the fuel injector but also provides a generic base for the installation of different connector plugs that can easily be clipped onto the extension of the fuel injector.

The features set forth in the dependent claims make possible advantageous developments of and improvements to the fuel injector described in the main claim.

It is also advantageous that the connector plug can be slid or clipped onto the metal hollow body by a retainer, the retainer e.g. being capable of being embodied as a spring ring that partially surrounds the metal hollow body.

Advantageously, the contact lugs of the magnet coil and of the connector plug are oriented parallel to one another and to the valve sleeve, which makes possible simple installation and subsequent connection.

It is additionally advantageous that both the fuel injector and the metal hollow body can be manufactured separately and can then be combined, with no need to modify the design of the conventional components of the fuel injectors.

### DRAWINGS

An exemplified embodiment of the invention is depicted in simplified fashion in the drawings and is explained in more detail in the description below. In the drawings:

FIG. 1 is a schematic section through an exemplified embodiment of a functional part of a fuel injector; and

FIG. 2 is a schematic section through the fuel injector depicted in FIG. 1, combined with the connector part configured according to the present invention.

### DESCRIPTION OF THE EXEMPLIFIED EMBODIMENT

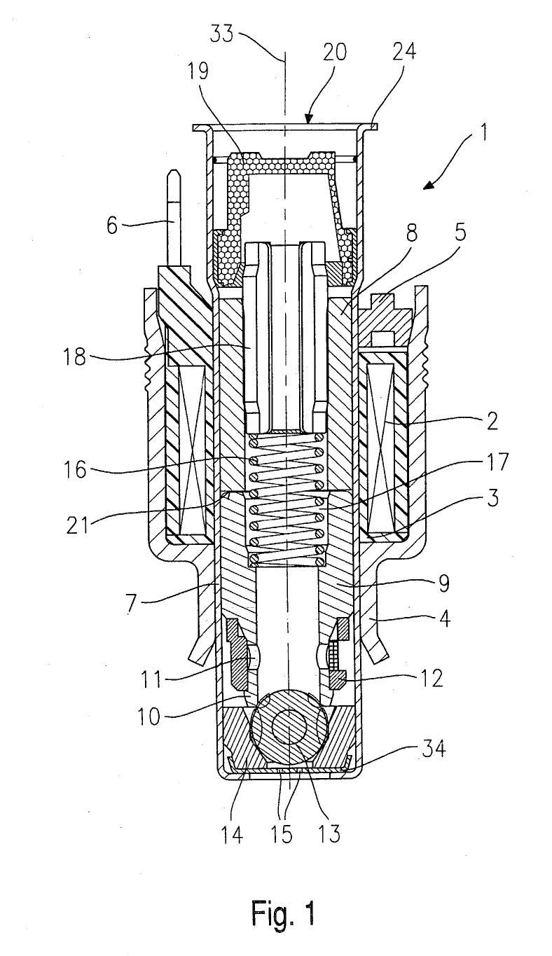

FIG. 1 shows, in a partial and schematic sectioned depiction, a longitudinal section through a fuel injector 1 that is suitable in particular for injecting fuel into an intake manifold (not depicted in further detail) of an internal combustion engine.

Fuel injector 1 encompasses a magnet coil 2 that is wound onto a coil support 3. Coil support 3 is encapsulated in a valve housing 4 and sealed by a cover 5. Configured on coil support 3 is a contact lug 6 that, in the exemplified embodiment, is oriented parallel to a longitudinal axis 33 of fuel injector 1.

Passing through coil support 3 is a valve sleeve 7 that is of tubular configuration and encompasses a support tube 8, injection-embedded or welded therein, that serves as the internal pole of magnet coil 2. Valve housing 4, for example, can serve as the external pole of magnet coil 2. Positioned on the outflow side of support tube 8 is an armature 9 which is configured integrally with a valve needle 10. Flowthrough openings 11, which direct the fuel flowing through fuel injector 1 to a sealing seat, are provided in valve needle 10.

An annular filter 12 for filtering the fuel is positioned in the region of flowthrough openings 11. Valve needle 10 is in working engagement, preferably by welding, with a valve closure member 13 (spherical in the exemplified embodiment) that, with a valve seat element 14, forms a sealing seat. Configured downstream from the sealing seat in a perforated spray disk 34 is at least one spray discharge opening 15 from which fuel is injected into the intake manifold (not depicted further).

When fuel injector 1 is in the inactive state, armature 9 is impinged upon by a return spring 16 in such a way that fuel injector 1 is held closed by the pressure of valve closure member 13 on valve seat element 14. Return spring 16 is positioned in a recess 17 of armature 9 and of support tube 8, and is preloaded by an adjusting sleeve 18. On the inflow side of adjusting sleeve 18, a cup-shaped filter element 19 is preferably pressed into valve sleeve 7. The fuel that is introduced through a central fuel inlet 20 flows through fuel injector 1 through recess 17 and flowthrough openings 11 to the sealing seat and to spray discharge opening 15.

When an electric current is conveyed to magnet coil 2 via an electrical line (not depicted in further detail) and contact lug 6, a magnetic field is established that, when sufficiently strong, pulls armature 9 against the force of return spring 16 into magnet coil 2, opposite to the flow direction of the fuel. A working gap 21 configured between armature 9 and support tube 8 is thereby closed. As a result of the motion of armature 9, valve needle 10 configured integrally with armature is also carried along in the linear stroke direction, so that valve closure member 13 lifts off from valve seat element 14 and fuel is directed to spray discharge opening 15.

Fuel injector 1 is closed as soon as the current energizing magnet coil 2 is shut off and the magnetic field has decayed sufficiently that return spring 16 pushes armature 9 away from support tube 8, so that valve needle 10 moves in the outflow direction and valve closure member 13 settles onto valve seat element 14.

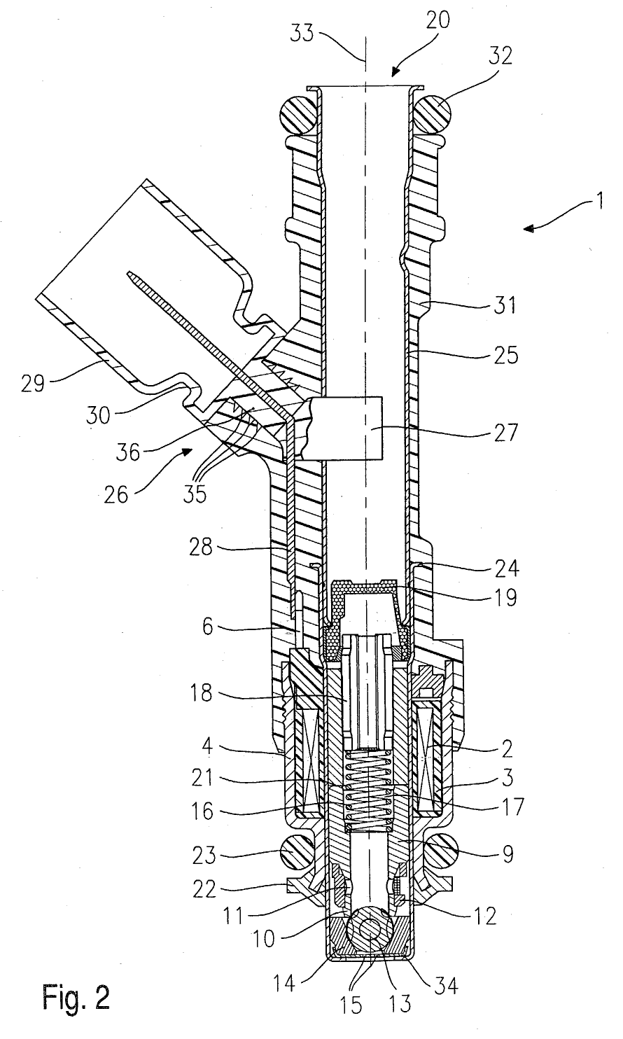

FIG. 2 shows, in a partial sectioned depiction, fuel injector 1 that is depicted in FIG. 1 and is assembled and equipped with the features according to the present invention. Identical components are labeled with matching reference characters. Repetition of the description of previously known components can be dispensed with.

Fuel injector 1 is depicted in FIG. 2 in a completely manufactured state. A collar 22 is placed or injection-molded onto valve housing 4 at its lower end, thereby forming an annular groove into which a first seal 23 is introduced.

An annular metal hollow body 25 is inserted into an inflow end 24 of valve sleeve 7 and is welded to valve sleeve 7 e.g. in the region of filter element 19. A customer-specific retainer 26 is slipped onto metal hollow body 25 by a retainer 27, preferably made of plastic, which is embodied e.g. as a spring ring and at least partially surrounds metal hollow body 25. Connector plug 26 has a contact lug 28 that is directed toward contact lug 6 of magnet coil 2 and is joined thereto after assembly by suitable techniques such as e.g. welding, soldering, or adhesive bonding, or by way of a crimped or plug connection.

In order to protect contact lug 28 during further processing of fuel injector 1, connector plug 26 has a plastic sleeve 29 that surrounds contact lug 28 and projects beyond it. Plastic sleeve 29 is also referred to as a “clip connector,” and possesses a circumferential groove 30 that, during further processing, serves as a mount for an injection-embedding mold.

After the assembly of connector plug 26, fuel injector 1 and metal hollow body 25 joined thereto are equipped with an injection-molded plastic sheath 31 and equipped, for mounting on a fuel distribution line, with a second seal 32. For that purpose, the respective customer-specific electrical connector plugs 26 are, for example, introduced into a customer's own injection-embedding molds.

Sealing between connector plug 26 and injection-molded plastic sheath 31 is accomplished by melting connector plug 26 in the region of specifically shaped, annularly circumferential ridges 35 in central region 36 of connector plug 26, for which reason the plastic of injection-molded plastic sheath 31 must have a higher melting point than that of connector plug 26.

Ideally, connector plug 26 is used in a specific desired color of plastic, so that connector plugs 26, serving for color identification, clearly characterize fuel injector 1 without additional instructions. With a color identification system of this kind, different valve types can be classified very easily.

With the features described above, it is possible to manufacture a fuel injector 1 having a generic magnet coil 2 and a generic contact lug 6 that can each be equipped with any desired electrical connector plug 26, with no need to have a test stand and fabrication device available at the factory for each of the different connector plugs 26.

The invention is not limited to the exemplified embodiment presented and is also applicable e.g. to fuel injectors 1 of any design.

What is claimed is:

1. A fuel injector (1), comprising a magnet coil (2) which coacts with an armature (9) that is impinged upon by a return spring (16) and that, together with a valve needle (10), forms an axially movable valve part, there being provided on the valve needle (10) a valve closure member (13) that, together with a valve seat element (14), forms a sealing seat; and comprising at least one contact lug (6) that is conductively connected to the magnet coil (2), wherein a metal hollow body (25) forms an inlet-side extension of the fuel injector (1) and is inserted into a valve sleeve (7), and a connector plug (26), having at least one contact lug (28) on a retainer (27), is clamped onto the metal hollow body (25) in such a way that each contact lug (28) of the connector plug (26) is conductively connected to a contact lug (6) of the magnet coil (2).

2. The fuel injector as defined in claim 1,
wherein the contact lug (6) of the magnet coil (2) is oriented parallel to the valve sleeve (7).

3. The fuel injector as defined in claim 1 or 2,
wherein the retainer (27) of the connector plug (26) at least partially surrounds the metal hollow body (25).

4. The fuel injector as defined in one of claims 1 through 3,
wherein the contact lug (28) of the connector plug (26) is oriented parallel to the connector (sic) lug (6) of the magnet coil (2).

5. The fuel injector as defined in one of claims 1 through 4,
wherein after the installation and connection of the contact lugs (6, 28), the connector plug (26) is immobilized on the metal hollow body (25) by an injection-molded plastic sheath (31).

6. The fuel injector as defined in one of claims 1 through 5,
wherein a plastic sleeve (29), provided on the connector plug (26), has a groove (30) on which an injection-embedding mold can be mounted.

7. The fuel injector as defined in claim 5 or 6,
wherein the connector plug (26) has, outside the retainer (27), a region on which at least one annularly elevated circumferential ridge (35) is provided.

8. The fuel injector as defined in claim 7,
wherein the plastic of the injection-molded plastic sheath (31) has a higher melting point than the plastic of the connector plug (26), so that when the connector plug (26) is injection-molded on, the circumferential ridges (35) are melted and a sealed join is thus achieved.
